(19) United States
(12) Patent Application Publication
(10) Pub. No.: US 2007/0227310 A1
(43) Pub. Date: Oct. 4, 2007

(54) Hand power tool

(76) Inventors: Heiko Roehm, Stuttgart (DE); Gyula Gondos, Miskolc (HU)

Correspondence Address: STRIKER, STRIKER & STENBY, 103 EAST NECK ROAD, HUNTINGTON, NY, 11743, US

(21) Appl. No.: 11/395,483

(22) Filed: Mar. 31, 2006

(51) Int. Cl. E21B 15/04; B25B 21/00; B25B 13/00

(52) U.S. Cl. 81/54; 173/2

(57) ABSTRACT

The invention describes a hand power tool, which is rechargeable battery-operated and includes a housing (10) with at least one upper part (11) for receiving at least one tool insert (20) and with a middle part (12) embodied as a hand grip (14), a holder (40) being provided for receiving tool inserts (20), and the tool holder (40) is connectable to the housing (10) by means of detent elements (47).

### PRIOR ART

The invention relates to a hand power tool as generically defined by the preamble to claim 1.

For some years, cordless hand power tools with a power supply that is independent from the power grid for the electric motor have gained broad use, since the independence from the power grid has many advantages for manipulating such hand power tools.

From German Patent Disclosure DE 103 45 135 A, a cordless screwdriver with a pistol-like hand grip is already known, in which a rechargeable battery for supplying voltage is integrated into the hand grip of the cordless screwdriver housing. For charging the battery, the cordless screwdriver is placed in a charging shell, which can be set down, standing securely, on a flat surface. In the region of the lower end of the hand grip, charge contact tongues are provided, which in the charging mode rest on charging contacts of the charging shell, without separate cables or coupling plugs having to be actuated.

From German Patent Disclosure DE 102 12 750 A, a hand power tool, such as a power drill or drill/screwdriver, on whose housing a battery pack system can be mounted. For mechanically connecting the housing to the battery pack system, detent elements are provided on the one hand, while for the electrical connection contact elements are present on the other. The battery pack may for instance be mounted on the base of the hand grip of the hand power tool, and at least one side face of the battery pack is embodied as a face to stand on, so that the hand power tool equipped with the battery pack system can be set down on a flat surface.

### DISCLOSURE OF THE INVENTION

The rechargeable battery-operated hand power tool of the invention advantageously has a holder for receiving tool inserts, which is connectable to the housing of the hand power tool by means of a detent connection. Thus the replaceable tool inserts can easily be carried along with the hand power tool as needed. The tool inserts may for instance be insertable bits for screwdrivers, drills, or percussion drills.

A further subject of the invention is a rechargeable battery-operated hand power tool which includes a holder for receiving tool inserts (hereinafter also simply called a tool holder) and a device for charging rechargeable batteries (hereinafter also simply called a charging device); the tool holder can advantageously be connected to the housing and/or the charging device by means of a detent connection. This means that the tool holder can be connected to either the housing of the hand power tool or to the charging device, or to both the housing of the hand power tool and the charging device. In particular, the tool holder is designed such that it can be selectively mounted on the housing or on the charging device. Thus the tool holder can be mounted on the housing of the hand power tool, and the hand power tool, with the tool holder, can be connected to the charging device.

The hand power tool of the invention has a housing with at least one upper part, which serves to receive at least one tool insert, and a middle part embodied as a hand grip.

In a preferred embodiment of the hand power tool, the housing has a lower part embodied as a base to stand on, and the tool holder or the charging device can be mounted in the region of the base, especially on the underside of the base.

In a first embodiment, the tool holder can be mounted on the underside of the base, and the charging device can be mounted on the tool holder.

In a second embodiment, the charging device can mounted on the underside of the base, and the tool holder can then be mounted on the charging device.

Preferably, the hand power tool includes a housing, in particular a two-shell housing, with an upper part which receives at least one electric motor, such as a conventional DC motor, and a gear, such as a multi-stage planetary gear; a middle part, embodied as a hand grip; and a lower part, embodied as a base to stand on. Via the gear, the electric motor in the upper part of the housing drives a work spindle, which has a chuck. The chuck may be a fast-action chuck, which is usual for power drills, for instance, or an insertable chuck or a magnetic chuck.

The upper part, middle part and lower part of the housing of the hand power tool are embodied in particular in one piece. The housing shape comprising the upper part, middle part and lower part, makes an advantageous distribution of the components over the entire housing possible, thus attaining a compact construction. The housing is preferably embodied as two shells, with one housing shell holding the components, such as the electric motor, gear, rechargeable battery, and printed circuit board.

The middle part of the hand power tool, embodied as a hand grip, is embodied in particular as a pistol-like hand grip. The pistol-like hand grip is preferred for ergonomic reasons, because it is especially handy and has an especially advantageous force transmission in the axis of the hand power tool that is parallel to the working direction. Within the context of the present invention, the working direction is understood to mean the direction in which the hand power tool is guided during operation, such as for drilling and screwdriving. Moreover, in the case of a pistol-like hand grip, disposing the ON-OFF switch in the form of a trigger is especially advantageous.

The lower part, embodied as a base to stand on, in particular has an underside that can be set down on a substantially flat surface. The underside is embodied such that it can be set down at least in part on a substantially flat surface. The hand power tool of the invention can be set down on the underside of the base, without further bracing, for instance in a holding or carrying element.

In the hand power tool of the invention with a base to stand on, the rechargeable battery is preferably integrated with the housing in the region of the hand grip. This makes an overall compact construction possible with at the same time great stability of the hand power tool. In particular, the base to stand on can be made comparatively flat, since it need not receive any batteries. Thus the entire structural height of the hand power tool of the invention is also less than in a comparable hand power tool with a rechargeable battery integrated into the base or with a battery embodied as a base. The structural height of the hand power tool is understood to be the maximal distance between the underside of the base and the top side of the upper part.

For this purpose, lithium ion cells are advantageously used, since because they have no memory effect and do not discharge on their own, they make a high number of charging and discharging cycles possible, as well as a long service life, and thus need not be replaced and can instead be permanently built into the housing. Lithium ion cells also have the advantage that because of their greater energy density, the weight of the hand power tool is less in comparison to a hand power tool with a rechargeable battery based on a nickel-cadmium or nickel-metal hybrid cell. For instance, three series-connected, cylindrical lithium ion cells, each of 3.6 V, for instance, for a total voltage of 10.8 V, may be provided. To design the hand power tool even more compactly, instead of the cylindrical individual cells, a single lithium polymer cell may be used, preferably one adapted to the contour of the hand grip.

The holder for receiving tool inserts includes a housing, in particular a shallow housing, which has receptacles for receiving the tool inserts. The receptacles may for instance be located in the side faces of the shallow housing. The tool inserts can be received in the receptacles by being pushed in, inserted, or clipped in place. The underside of the tool holder can also be provided with receptacles for receiving tool inserts.

Preferably, the holder for receiving tool inserts is located in the region of the base. In particular, the holder is located on the underside of the base. In this embodiment, the underside of the tool holder is designed such that it can be set down on a substantially flat surface, and the underside of the base and the underside of the tool holder can selectively serve as a surface to stand on, depending on whether the hand power tool is used with or without a tool holder.

Connecting the holder for receiving tool inserts to the housing of the hand power tool by means of a detent connection has the advantage that the connection can easily be undone. In particular, both the base without a tool holder and the base with a tool holder are designed such that the hand power tool can be set down on its base with and without a tool holder, on a substantially flat surface.

If a device for charging the battery is additionally provided, then the charging device can be connected undoably, preferably by means of a detent connection, to the housing of the hand power tool. In particular, the base to stand on is embodied such that for charging the at least one rechargeable battery, the base can be set down in a device for charging a rechargeable battery. Thus in addition to the charging function, the charging device has a parking function, that is, the function of a stand. The charging device is embodied such that the base to stand on can be set down in the charging device. To that end, the charging device has a recess for receiving the base to stand on. The recess is designed in particular such that the base to stand on engages the recess in form-locking fashion. Hence the depth of the recess, for instance, is essentially equivalent to the height of the base to stand on. Increased stability of the base, standing in the recess of the charging device, can be achieved by means of an additional force-locking connection, in particular a snap connection, between the base and the recess. For that purpose, the base and the recess are provided with snap elements that engage on one another. This makes a stable but easily undone connection of the base with the recess possible. Alternatively, however, the receptacle may be embodied as very shallow, so that the base can be set down substantially on the top side of the charging device. The underside of the base then practically rests on the top side of the charging device. The underside of the base may also be set down on the top side of the charging device without there being a receptacle in the charging device. Adequate stability can be achieved for instance by means of a detent or snap connection between the underside of the base and the top side of the charging device.

The device for charging the battery is detachably connectable to the holder for receiving tool inserts, by means of a detent connection. In a first embodiment, the tool holder is detachably connectable to the underside of the base, and the charging device is detachably connectable to the underside of the tool holder. In a second embodiment, the charging device is detachably connectable to the hand power tool, in particular to the base of the hand power tool, and the tool holder is in turn detachably connectable to the underside of the charging device.

For the electrical contacting for charging the at least one battery of the hand power tool, contact elements are provided on the hand power tool and on the charging device. For this purpose, contact elements for electrically connecting the base to the charging device are provided in particular on the base, and the contact elements are preferably located on the underside of the base. For example, either one receptacle for each contact element, or one receptacle for both contact elements together, is provided on the underside of the base, so as not to impair the stability of the base because of the contact elements that protrude out of the housing. Alternatively, the contact elements may be provided on one or more side faces.

The contact elements of the charging device protrude from the housing of the charging device, particularly on its top side, and are positioned such that when the hand power tool is set down on or in the charging device, the contact elements of the charging device contact those of the hand power tool. To that end, a receptacle for receiving at least the underside of the base or the entire base may for instance be provided; the contact elements are located on at least one inside face, such as the bottom face, or at least one side face.

In the first embodiment, in which the tool holder is located with the base of the hand power tool and the charging device is located on the underside of the tool holder, the tool holder must be designed such that it is possible to set the hand power tool down in or on the charging device either with or without the tool holder. This makes for the greatest possible user-friendliness, since the user can selectively work with and without a tool holder. Accordingly, in this embodiment, the tool holder must also have contact elements, which on the one hand contact the contact elements of the charging device and on the other contact the contact elements of the base.

In a simple embodiment, the tool holder may also be designed such that the hand power tool can be set down in or on the charging device only with the tool holder, but not without the tool holder. For that purpose, it is necessary that openings be provided in the tool holder, especially on its underside, through which the contact elements of the charging device can reach. The contact elements themselves protrude far enough out of the housing of the charging device that, through the tool holder, they contact the contact elements of the hand power tool.

Means for electronic torque limitation are preferably provided In the base. An electronic torque limiter in particular makes a smaller structural length of the hand power tool possible, compared to a hand power tool with mechanical torque coupling. Within the context of the present invention, the structural length of a hand power tool is understood to mean the length of its upper part. For targeted triggering of the torque limitation, at least one printed circuit board with the appropriate components is provided in the base. An electronic torque limiter or torque shutoff is known in the prior art. In it, the current-controlling principle of a shutoff screwdriver can for instance be employed. In preliminary tests, a shutoff value for the torque has been ascertained that is adjusted at a potentiometer. In operation of the hand power tool, the current intensity, which increases in proportion to the torque of the motor, is compared, for instance via a digital controller, with the current intensity that increases at the potentiometer. When the set-point value is reached, a shutoff pulse is tripped, which stops the electric motor. The fact that the maximum torque has been reached and the torque has been shut off can be imparted to the user by means of an acoustical signal, such as a chirping tone. The risk of a thermal overload can also be displayed by means of a further acoustical signal, such as three successive chirping tones.

To adjust the torque, the means for electronic torque limitation have a control knob, preferably in the base, and especially preferably on the top side of the base. The desired torque can be adjusted using a scale on the circumference of the control knob.

In a further embodiment of the hand power tool of the invention, the base has at least one radiation source. The radiation source is preferably a light-emitting diode (LED). The radiation source, especially the light-emitting diode, is located in an outer region of the lower part embodied as a base to stand on. The radiation source is preferably located in the region of the free end of the base, since then the radiation source will not be covered by the user's hand. The free end of the base is understood to be the end that is facing away from the middle part of the housing that is embodied as a hand grip. The radiation source is also preferably located on the top side of the base and is oriented such that the work area is illuminated. Within the context of the present invention, the work area of a hand power tool is understood to be the area which includes at least the free end of the tool insert, such as a drill bit or screwdriver bit, that is fastened in the upper part.

The radiation source, in particular the light-emitting diode, is preferably covered by a substantially transparent covering disk which has convex curvature, so that the cover disk acts as a focusing lens and focuses the beam of light, emitted by the light-emitting diode, onto the work area of the hand power tool.

In a further embodiment, the base has at least one viewing area for displaying the charge status of the battery. The charge status is displayed in particular by means of a light-emitting diode. A plurality of viewing areas may also be provided, each displaying a different charge status of the battery. A plurality of viewing areas may be located arbitrarily relative to one another. For instance, three viewing areas may be located side by side, with each viewing area displaying a certain proportion of the charge capacity, such as 100%, 60%, and 30%. If there are a plurality of viewing areas for displaying different charge statuses, then one light-emitting diode, each of a different color, may be provided for each charge status. Preferably, the at least one viewing area is located on the top side of the base. This makes the viewing area readily visible to the user.

In a preferred embodiment, the base, and in particular the top side of the base, holds at least one radiation source, one viewing area for displaying the charge status of the battery, and one device for adjusting the torque.

A further subject is a holder for receiving tool inserts for the rechargeable battery-operated hand power tool of the invention; the holder includes a housing with at least one receptacle for receiving at least one tool insert, and the holder has at least one connecting element for a detent connection with a hand power tool and/or with a device for charging rechargeable batteries.

The hand power tool of the invention is in particular a rechargeable battery-operated hand power tool, such as a cordless power drill, a cordless power percussion drill, or a cordless screwdriver.

The invention is described in further detail below in conjunction with the accompanying drawings.

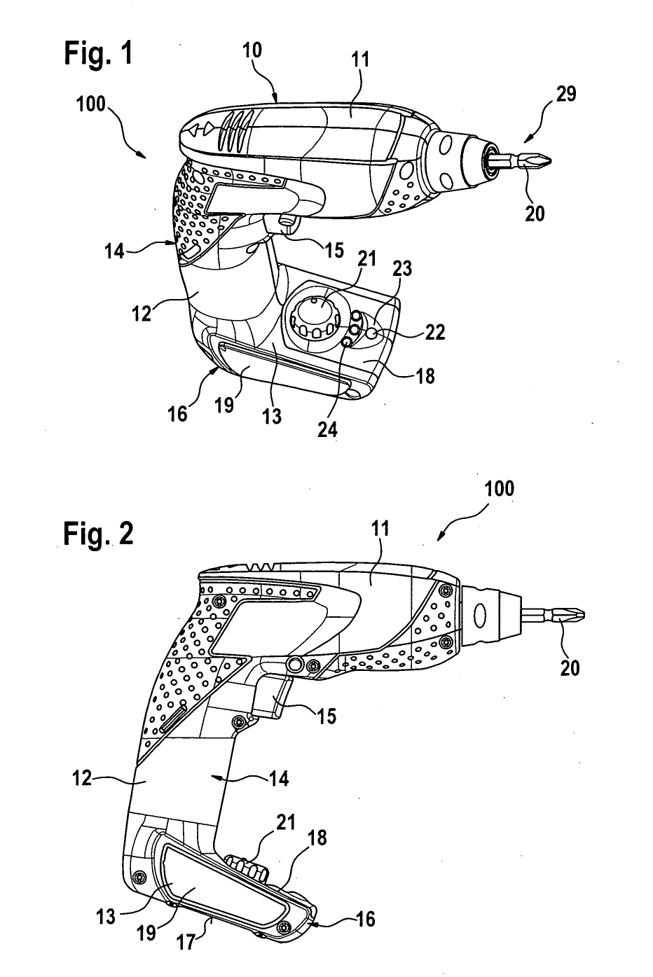

FIG. 1 shows one embodiment of the hand power tool of the invention in perspective;

FIG. 2 shows the hand power tool of FIG. 1 in a side view;

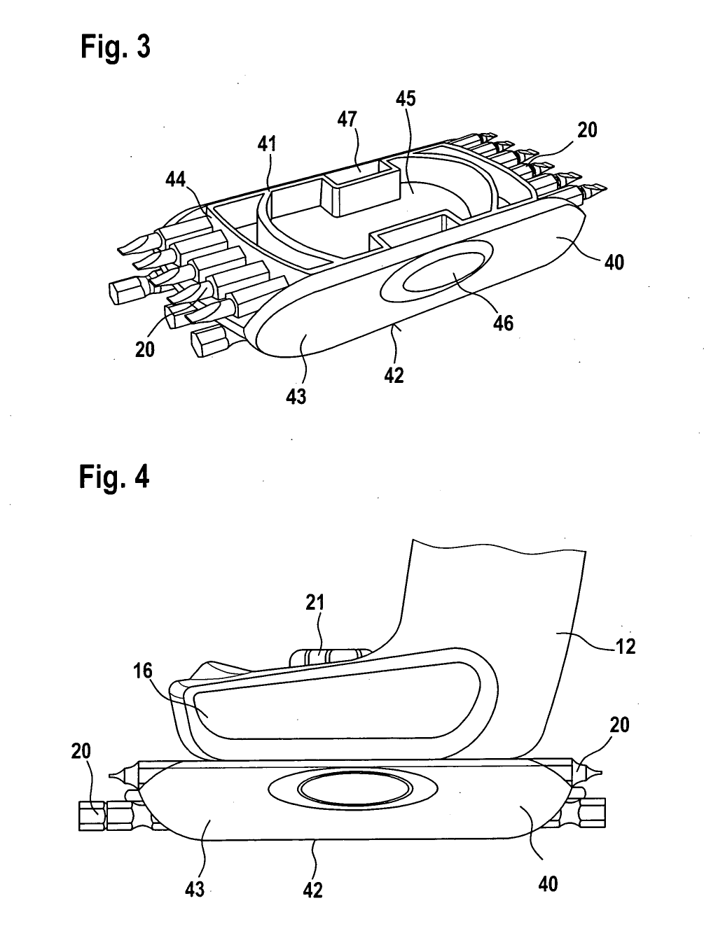

FIG. 3 schematically shows an embodiment of a holder for receiving tool inserts;

FIG. 4 is a detail of the hand power tool of FIG. 1 together with the tool holder of FIG. 3, shown schematically;

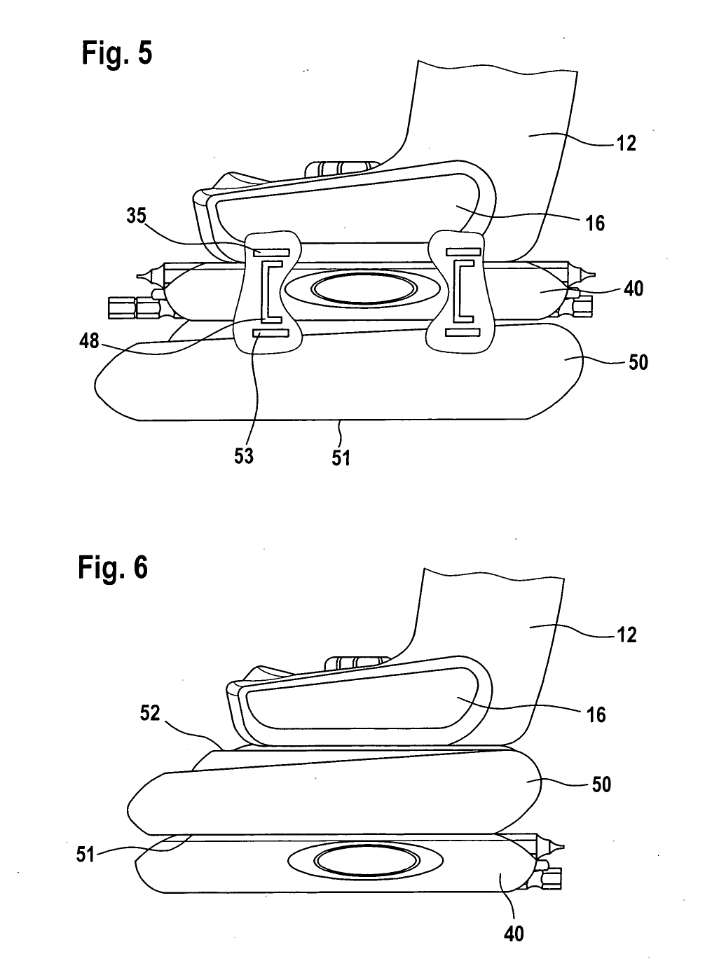

FIG. 5 is a detail of the hand power tool of FIG. 1 together with the tool holder of FIG. 3 and a charging device in a first embodiment, shown schematically;

FIG. 6 is a detail of the hand power tool of FIG. 1 together with the tool holder of FIG. 3 and a charging device in a second embodiment, shown schematically;

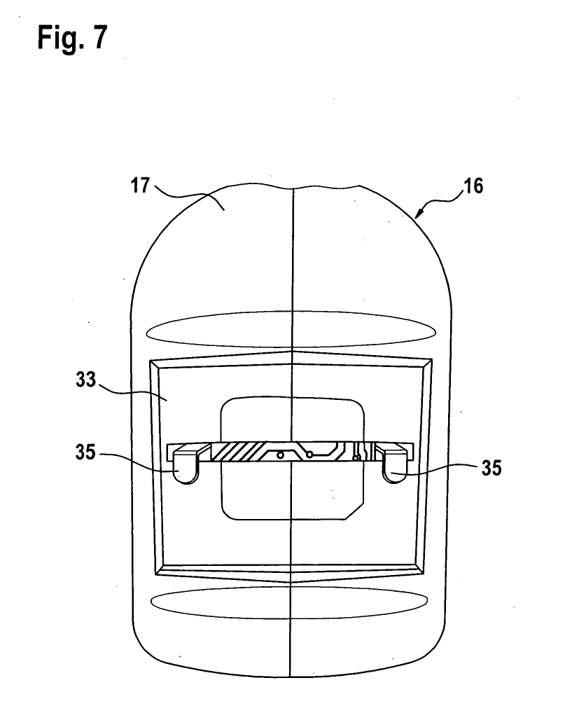

FIG. 7 shows the underside of the base for the hand power tool of FIG. 1 to stand on, in plan view.

In FIG. 1, a preferred embodiment of a cordless screwdriver 100 is shown. The housing 10 comprises an upper part 11, a middle part 12, and a lower part 13. The middle part 12 is embodied in the form of a pistol-like hand grip 14; that is, the upper part 11 and the middle part 12 are located in it at an angle to one another, in a way similar to a pistol. In the upper region of the hand grip 14, below the upper part 11, an ON/OFF switch 15 in the form of a trigger is provided. It is actuated with the index finger, in a way similar to a pistol. The middle part 12 embodied as a hand grip 14 receives at least one rechargeable battery (not shown). The lower part 13 is embodied as a base 16 to stand on. The base 16 has a substantially flat underside 17, on which the base 16 can be set down on a substantially flat face. The lower part 13 is likewise located at an angle to the middle part 12. The upper part 11, middle part 12, and lower part 13 are in one piece, and the angled disposition of the upper part 11, middle part 12 and lower part 13 means that the housing 10 is C-shaped.

In the base 16, means for electronic torque limitation are provided, which include at least one printed circuit board 25 (see FIG. 5), a potentiometer, and a control knob 21 for adjusting the torque, using a scale (not shown) located on the circumference of the control knob 21 on the top side 18 of the base 16.

The base 16, on its top side 18, also has at least one radiation source 22, in the form of a light-emitting diode (LED). The radiation source is located and oriented such that the work area 29 is illuminated. The work area 29 is understood to mean that region which includes at least the free end of the tool insert 20, in this case a screwdriver bit, that is fastened in the upper part 11.

The radiation source 22 in the form of a light-emitting diode is preferably covered by a substantially transparent cover disk 23, which is convex in curvature, so that the cover disk 23 serves as a focusing lens and focuses the beam of light, emitting by the light-emitting diode, onto the work area 29 of the cordless drill 100.

The base 16, on its top side 18, moreover has at least one viewing area 24 for displaying the charge status of the battery. The charge status is displayed in particular by means of a light-emitting diode. In the embodiment shown in FIG. 1, three viewing areas 24 are provided, which each display a different charge status of the battery, such as 100%, 60%, and 30% of the charge capacity. The three viewing areas 24 are formed by three different light-emitting diodes, with three different colors, such as green, yellow, and red.

In FIG. 3, a preferred embodiment of a holder 40 for receiving tool inserts 20 is shown schematically. The tool holder 40 comprises a shallow housing 41, with an underside 42 and side faces 43. The tool holder 40 may be essentially hollow on its inside, making the weight of the tool holder 40 as low as possible. The tool holder 40 can be connected detachably, for instance by force-locking, to the underside 17 of the base 16 of the cordless drill 100. To that end, the substantially hollow housing 41 is open on its top side 45, and on two diametrically opposed side faces 43 it has detent or snap elements, for instance. In the embodiment shown in FIG. 3, there is one pushbutton 46 on each of two diametrically opposed side faces 43, and with it, the snap elements 47 located on the inner faces of the side faces 43 of the housing 41 can be pressed together. Thus the top side 45 of the tool holder 40 can be placed in form-locking and force-locking fashion in suitable receptacles (not shown) on the underside 17 of the base 16.

If the tool holder 40 is connected to the underside 17 of the base 16, the cordless drill 100 can still be set down on the underside 42 of the tool holder 40. This means that even the underside 42 of the tool holder 40 is designed such that the cordless screwdriver 100 can be set down, with the tool holder 40, on a substantially flat face (see FIG. 4).

For receiving tool inserts 20, the tool holder 40, in the embodiment shown, has receptacles 44 on both side faces 43, which point in and counter to the working direction, and the tool inserts 20 are pushed, inserted, clipped, or the like into these receptacles. The receptacles 44 are located in two substantially parallel rows one above the other in FIG. 3. However, the receptacles 44 may also be arranged in some other way relative to one another. The underside 42 can also serve (not shown) to receive tool inserts 20. To that end, the underside 42 may for instance have individual, smaller receptacles, into each of which one tool insert 20 can for instance be inserted. Alternatively, a large-area receptacle may be provided on the underside 42, and inside it, clamplike connecting elements, for instance, may be mounted, into which the tool inserts 20 can be inserted individually. If tool inserts 20 can be mounted on the underside 42, then the receptacles for receiving the tool inserts 20 are let so deeply into the underside 42 of the housing 41 that mounting the tool inserts 20 does not impair the stability of the cordless screwdriver 100 as it stands on the underside 42 of the tool holder 40.

Both the base 16 and the tool holder 40 are furthermore embodied such that they are detachably connectable to a device 50 for charging the rechargeable battery. The base 16 has contact elements (not shown) on its underside 42 for electrically connecting the base 16 to the charging device 50. The charging device 50 likewise has contact elements (not shown), which for charging the battery contact the contact elements of the base 16. The charging device 50 is connected to a power supply via a cord (not shown).

FIGS. 5 and 6 schematically show two embodiments of a charging device 50, which can be connected detachably to the tool holder 40 on the one hand and to the base 16 on the other. In FIG. 5, the tool holder 40 is connected to the underside 17 of the base 16, for instance as shown in FIGS. 3 and 4. The charging device 50 is mounted detachably, for instance via a form-locking and/or force-locking connection, on the underside 42 of the tool holder 40. In a simple embodiment, the contact elements of the charging device reach through the tool holder 40 in order to contact the contact elements on the underside 17 of the base 16. For that purpose, openings may for instance be provided in the underside 42 of the tool holder 40, through which openings the contact elements reach (not shown). To enhance the user-friendliness, however, in a preferred embodiment it is provided that the cordless screwdriver 100 can be set down in or on the charging device 50 both with and without the tool holder 40. FIG. 5 schematically shows the location of the contact elements. The tool holder 40 has contact elements 48, which contact the contact elements 53 of the charging device 50 on the one hand and the contact elements 35 of the base 16 on the other. These contact elements 48 may for instance be located in openings (not shown) in the underside 42, so that the contact elements 48 of the tool holder 40 are contacted from below by the contact elements 53 of the charging device 50 and from above by the contact elements 35 of the base 16.

Alternatively, in FIG. 6 a charging device 50 is shown which is detachably connected directly to the underside 17 of the base 16; the tool holder 40 is mounted on the underside 51 of the charging device 50. In this case, the tool holder 40 may for instance be embodied as in FIG. 3; on the underside 51 of the charging device 50, suitable connecting elements for the detent connection with the detent elements 47 are provided. In the embodiment of the charging device 50 shown in FIG. 6, the base 16 can be set down essentially on the top side 52 of the charging device. Alternatively, the top side 52 of the charging device 50 can also be embodied such that the base 16 is received (not shown) in a receptacle of the charging device 50.

The base 16 with or without the tool holder 40 is embodied such that for charging the battery, the base 16 can be set down in the charging device 50. Thus besides its charging function, the charging device 50 has a parking function, that is, it functions as a stand. The charging device 50 is in turn designed such that it can be set down on a substantially flat surface.

FIG. 7 shows an embodiment of an underside 17 of a base 16 of the cordless screwdriver 100 that is suitable for instance for contacting a charging device 50 of FIG. 6. On the underside 17 of the base 16, are in the recess 33 for electrically connecting the base 16 to the charging device 50. The contact elements of the charging device 50 protrude in a corresponding region from the housing of the charging device 50, so that the contact elements of the charging device 50 contact the contact elements 35 of the base 16.

1. A hand power tool, which is rechargeable battery-operated and includes a housing (10) with at least one upper part (11) for receiving at least one tool insert (20) and with a middle part (12) embodied as a hand grip (14), a holder (40) being provided for receiving tool inserts (20), characterized in that the tool holder (40) is connectable to the housing (10) by means of detent elements (47).

2. A hand power tool, which is rechargeable battery-operated and includes a housing (10) with at least one upper part (11) for receiving at least one tool insert (20) and with a middle part (12) embodied as a hand grip (14), a holder (40) being provided for receiving tool inserts (20), and a device (50) for charging rechargeable batteries is provided, characterized in that the tool holder (40) is connectable to the housing (10) and/or to the charging device (50) by means by means of a detent connection.

3. The hand power tool as defined by claims 1, characterized in that the housing (10) has a lower part (13) embodied as a base (16) to stand on, and the tool holder (40) or the charging device (50) is mountable in the region of the base (16).

4. The hand power tool as defined by claim 3, characterized in that the tool holder (40) or the charging device (50) is mountable on the underside (17) of the base (16).

5. The hand power tool as defined by claim 4, characterized in that the tool holder (40) is mountable on the underside (17) of the base (16), and the charging device (50) is mountable on the holder (40).

6. The hand power tool as defined by claim 4, characterized in that the tool holder (40) is mountable on the underside (17) of the base (16), and the tool holder (40) is mountable on the charging device (50).

7. The hand power tool as defined by claim 1, characterized in that the tool holder (40) includes a housing (41), which has at least one pushbutton (46) for undoing the detent connection.

8. The hand power tool as defined by claim 1, characterized in that the housing (41) has at least one side face (43), which has receptacles (44) for receiving the tool inserts (20).

9. The hand power tool as defined by claim 1, characterized in that the housing (41) has an underside (42), which has receptacles for receiving the tool inserts (20).

10. A holder for receiving tool inserts (20) for a rechargeable battery-operated hand power tool as defined by claim 1, in which the holder includes a housing (41) with at least one receptacle (44) for receiving at least one tool insert (20), characterized in that the holder has at least one connecting element (47) for a detent connection to a hand power tool and/or to a device for charging rechargeable batteries.
